(19) United States
(12) Patent Application Publication
(10) Pub. No.: US 2026/0208879 A1
(43) Pub. Date: Jul. 23, 2026

(54) SPARK CONTAINMENT CAP PLATE

(71) Applicant: Airbus Operations Limited, FILTON, BRISTOL (GB)

(72) Inventors: Matthew CROSS, FILTON, BRISTOL (GB); Richard DOBBIN, FILTON, BRISTOL (GB); Stephen LAMYMAN, FILTON, BRISTOL (GB)

(21) Appl. No.: 19/157,800

(22) PCT Filed: Apr. 15, 2024
(86) PCT No.: PCT/EP2024/060125

§ 371 Date: Aug. 19, 2025

(30) Foreign Application Priority Data
Apr. 30, 2023 (GB) 2306409.0

(51) Int. Cl. B64D 45/02; B64F 5/10; F16B 37/14; H01B 17/38; H01B 17/42

(52) U.S. Cl. CPC B64D 45/02; B64F 5/10; F16B 37/14; H01B 17/38; H01B 17/42

(57) ABSTRACT

A spark containment cap plate with a base and two or more spark containment caps. Each cap has a cover portion which extends from the base and defines a cavity inside the cap, inside which an end of a fastener is enclosed. Also a fastener joint with a structure; two or more fasteners, each fastener having an end protruding from a surface of the structure; and a spark containment cap plate. The plate has a base and two or more spark containment caps. Each cap has a cover portion extending from the base and defining a cavity inside the spark containment cap inside which the ends of the fasteners. A cured sealing material is provided between the cap plate and the structure which secures the cap plate to the structure in such a position that each end of each fastener is enclosed within a spark containment cap.

### CROSS-REFERENCE TO RELATED APPLICATIONS

This application is a national phase of International Patent Application No. PCT/EP2024/060125, filed on Apr. 15, 2024, which claims the benefit of Great Britan Patent Application No. 2306409.0, filed on Apr. 30, 2023, the entire disclosures of which are incorporated herein by way of reference.

### FIELD OF THE INVENTION

The present invention relates to a spark containment cap plate. The present invention also relates to a fastener joint, an aircraft comprising at least one of the spark containment cap plate and the fastening joint, and also relates to a method of securing a fastener and a spark containment cap plate to a structure.

### BACKGROUND OF THE INVENTION

Large passenger aircraft are typically struck by lightning once or twice a year, each lightning bolt striking with up to 200,000 amps of electrical current that seeks the path of least electrical resistance. Many modern passenger aircraft have exterior surfaces made from composite materials which have a very high electrical resistance. There is therefore a high probability of lightning attachment at any of the many metallic fasteners in the exterior surface, which have a much lower electrical resistance. In the wing, some of these fasteners pass through the outer wing skin into the fuel tank.

In the event of a lightning strike attaching to a fastener, sparking or plasma or out-gassing may occur. Indeed a lightning strike at a fastener which is at a fuel tank boundary, and therefore immersed in fuel or vapor rich gas, could provide sparking and hot gas ignition sources which could cause ignition of the fuel.

It is well known to suppress such sparking by enclosing fasteners within spark containment caps. FIG. 1 shows a prior art example of a fastener joint comprising a spark containment cap as described in EP4112479A1. FIG. 1 shows a fastener joint 10 comprising a blind fastener 12 which has been fastened to a structure 11. A spark containment cap 13 is fixed to the structure 11 by a cured sealing material in the form of adhesive 14 provided between the base 15 and the surface of the structure 11. The cap 13 comprises an enclosed body 18. The body 18 has a base 15 and a cover portion 19 which extends from the base 15. The base 33 and cover portion 34 together define a cavity 35 within the enclosed body 32. The blind fastener 12 protrudes through the hole 16 formed in the structure 11 and the base 15 of the cap 13, such that the end of the fastener is enclosed within the cavity 17 in the enclosed body 18 defined by the base 15 and the cover portion 19.

Spark containment caps such as those described in EP4112479A1 provide good lightning strike protection at the fasteners. However, a large passenger aircraft can contain thousands of fasteners, and it can take a long time to install all the spark containment caps required to cover each of the fasteners.

### SUMMARY OF THE INVENTION

A first aspect of the invention provides a spark containment cap plate comprising: a base; and two or more spark containment caps; each spark containment cap comprising a cover portion which extends from the base, the cover portion defining a cavity inside the spark containment cap inside which the end of a fastener can be enclosed.

With such an arrangement, it is possible to fix multiple spark containment caps in place at a time. The spark containment cap plate may allow the spark containment caps to be easily placed, and with a high level of precision, onto a structure that will contain multiple fasteners which require lightning protection. As a result, this can greatly reduce the time required for assembly where the spark containment cap plate is used.

The base may comprise an adhering surface for adhering the spark containment cap plate to a structure. As such, a robust adhesive bond between the spark containment cap and a structure to which it is to be fixed can be easily achieved.

The base may comprise one or more alignment features. This may aid the accurate positioning of the spark containment cap plate onto a structure. This is particularly relevant if the spark containment cap plate is to be positioned and adhered to a structure prior to any holes being drilled in the structure for fasteners.

The one or more alignment features may be engageable with a corresponding feature on a structural element to which the spark containment cap plate is to be secured. This can provide a quicker accurate positioning of the spark containment cap plate in place on a structure.

The base may be substantially planar. This will enable the spark containment cap plate to be fixed to a planar surface of a structure.

The base may have a non-planar profiled shape. As a result, the base can be profiled to fit a non-flat structural element to which it is to be fixed, or could be complex in shape to fit a complex structural profile.

The base may comprise two or more apertures, and a spark containment cap may be located over each aperture. As such the base is already provided with apertures or holes in the correct positions through which fasteners can be received. This can make the positioning of the spark containment caps onto the base easier.

The base may comprise sacrificial material into which openings can be formed such that fastener ends can be received into the cavities inside the two or more spark containment caps. This allows for the holes to be formed at a later stage during manufacturing or assembly, and reduces the possibility of any misalignment of apertures.

The two or more spark containment caps may be adhered to the base to form the spark containment cap plate. Adhering the caps to the base allows for a fast and strong bond between the caps and the base.

Each spark containment cap may comprise a cap base, and the cap base may be adhered to the base.

The cover portion of each spark containment cap may comprise an annular opening, and each spark containment cap is adhered to the base at the annular opening.

The base and the two or more spark containment caps may be formed from a single piece, and the spark containment caps may be molded from the material that forms the base. This allows for the whole spark containment cap plate to be formed from a single piece of material, and can reduce the cost and weight of the spark containment cap plate.

The base may be formed of an electrically insulating material. As a result, the spark containment cap plate can provide two independent lightning protection features in one product: the base provides robust electrical isolation for a structure on which it is attached as well as the fasteners fastened attached thereto, and also the spark containment cap provides containment for any voltage sparking and outgassing.

According to a second aspect of the invention, there is provided a fastener joint comprising: a structure; two or more fasteners, each fastener having a fastener end protruding from a surface of the structure; and a spark containment cap plate, the spark containment cap plate comprising: a base; and two or more spark containment caps; each of the spark containment caps comprising a cover portion extending from the base, the cover portion defining a cavity inside the spark containment cap inside which the end of a fastener can be enclosed; and a cured sealing material provided between the spark containment cap plate and the structure which secures the spark containment cap plate to the structure in such a position that each end of each fastener is enclosed within a spark containment cap.

According to a third aspect of the invention, there is provided a method of securing a fastener and a spark containment cap plate to a structure, the method comprising: fixing a spark containment cap plate as claimed in any one of claims 1 to 12 onto a surface of the structure; forming a hole through at least one of structure and the spark containment cap plate at a location where the hole aligns with a spark containment cap; and inserting a fastener through the hole and tightening the fastener to secure it to the structure.

With such a method, the time required to position multiple spark containment caps in place onto the structure can be greatly reduced. The step of fixing a spark containment cap plate onto a surface of the structure places multiple spark containment caps in place onto the structure. This also can greatly simplify the assembly process.

The step of fixing the spark containment cap plate onto the surface of the structure may comprise applying adhesive between the base of the spark containment cap plate and the structure, and curing the adhesive.

The step of forming a hole through at least one of the structure and the spark containment cap plate may comprise drilling a common hole through the structure and the base of the affixed spark containment cap plate.

According to a fourth aspect of the invention, there is provided an aircraft comprising at least one of a spark containment cap plate or a fastener joint as described in any of the statements above.

It will of course be appreciated that features described in relation to one aspect of the present invention may be incorporated into other aspects of the present invention. For example, the method of the invention may incorporate any of the features described with reference to the apparatus of the invention and vice versa.

### BRIEF DESCRIPTION OF THE DRAWINGS

Embodiments of the invention will now be described, by way of example only, with reference to the accompanying drawings, in which:

FIG. 1 shows a prior art example of a fastener joint comprising a spark containment cap;

FIG. 2A shows a cross-sectional view of a spark containment cap plate according to a first embodiment;

FIG. 2B shows a cross-sectional view of various steps of a method of forming a fastener joint comprising the spark containment cap plate of FIG. 2A;

FIG. 2C shows an enlarged portion of FIG. 2B;

FIG. 3A shows a cross-sectional view of a spark containment cap plate according to a second embodiment;

FIG. 3B shows a cross-sectional view of various steps of a method of forming a fastener joint comprising the spark containment cap plate of FIG. 3A;

FIG. 3C shows an enlarged portion of FIG. 3B;

FIG. 4A shows a cross-sectional view of a spark containment cap plate according to a third embodiment;

FIG. 4B shows a cross-sectional view of various steps of a method of forming a fastener joint comprising the spark containment cap plate of FIG. 4A;

FIG. 4C shows an enlarged portion of FIG. 4B;

FIG. 5A shows a first step of the installation of a spark containment cap plate onto a structure having a complex shape;

FIG. 5B shows a second step of the installation of a spark containment cap plate onto a structure having a complex shape;

FIG. 6 shows the installation of a further embodiment of a spark containment cap plate onto a structure having a complex shape; and

FIG. 7 is a perspective view of an aircraft.

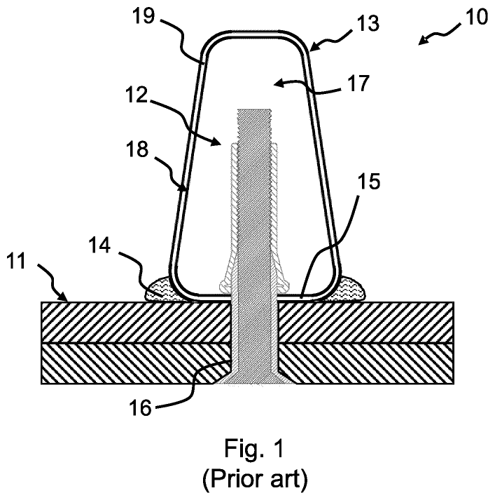

### DETAILED DESCRIPTION OF EMBODIMENT(S)

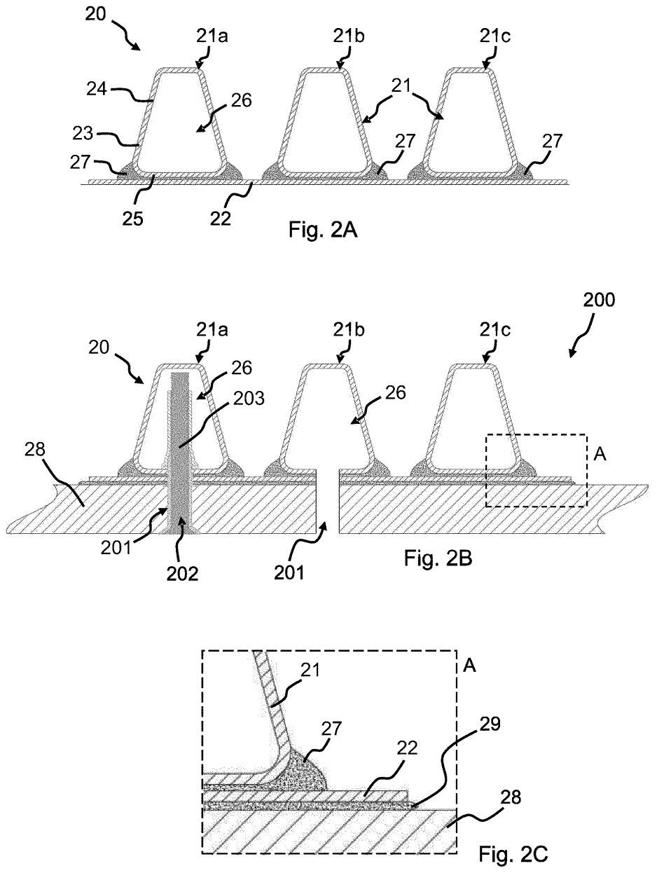

FIG. 2A shows a cross-sectional view through a first embodiment of a spark containment cap plate 20. The spark containment cap plate 20 comprises a base 22 and a number of spark containment caps 21 fixed to the base 22. In the embodiment shown, there are three spark containment caps 21a, 21b, 21c. For clarity, reference numerals for features of the spark containment cap will mostly only be shown in relation to spark containment cap 21a, however it will be understood that each of the spark containment caps 21a, 21b and 21c are identical, and so the reference numbers would also apply to 21b and 21c as well.

Each spark containment cap 21, which may be referred to herein more simply as cap 21, comprises an enclosed body 23. The body 23 has a cap base 25 and a cover portion 24 which extends from the cap base 25. The cap base 25 and cover portion 24 together define a cavity 26 within the enclosed body 23. It is into this cavity 26 that the end of a fastener can be received, which will be described in more detail below. The cap base 25 provides an adhering surface that is used for adhering the cap 21 to the base 22. In this way, it can be said that the cover portion 24 also extends away from the base 22. Adhesive 27 is shown between the caps 21a, 21b, 21c and the base 22, the adhesive 27 can be an epoxy adhesive, shim material or polysulphide sealant. For example, the epoxy adhesive may be a two-part epoxy adhesive such as 3M™ Scotch-Weld™ Structural Epoxy Adhesive 9323 or 3M™ Scotch-Weld™ Structural Epoxy Adhesive EC-7256 B/A. During assembly of the spark containment cap plate 20, adhesive 27 is applied to the base 22 and the spark containment caps 21 are positioned on the base 22 and allowed to cure. Excess adhesive may form a bead around the periphery of the cap 21 as shown in FIG. 2A. This bead helps to strengthen the bond between the cap 21 and the base 22, and also later acts to seal the cavity 26 inside the body 23 once a fastener is fitted in place in order to prevent escape of outgassing products. The seal between the cap 21 and the base 22 also prevents the ingress of fuel, water or other contaminants into the cavity 26, and also prevents plasma or other out-gassing products from exiting the cavity in the event of a lightning strike.

The base 22 is formed of polymer or Glass Reinforced Plastic and is sized to fit a specific structural element of the wing/fuel tank. By giving the spark containment cap plate 20 a large base 22, this allows the caps 21 to be easily placed in precisely the right position onto a structure and also allows multiple caps 21 to be placed on one base 22 (three shown in FIG. 2A), to allow for the installation of multiple caps 21 in one operation, thus saving significant time and cost. Although not shown in this embodiment, this also allows for different sized caps 21 to be installed together dependent on the specific fastener that the caps will be protecting.

In this embodiment, the caps 21 are manufactured as a single piece by blow molding. Blow molding has lower tooling and production costs compared to injection molding, and can offer a quicker, easier and cheaper manufacturing alternative to typical spark containment caps. The caps 21 are required to be formed of a material which can be blow molded, but which is also resistant to long term exposure to fuel. Examples of such a material could be Nylon PA6, PA66 and PA12. Another example may be ULTEM™ 2300, although this material would need to be injection molded, not blow molded. These materials may require additional treatment or primer paint application to enhance adhesive properties depending on the requirements of the caps 21.

FIG. 2B shows a cross-sectional view of the spark containment cap plate 20 affixed to a structure 28, where each of the caps 21a, 21b and 21c are at different steps of a method of forming a fastener joint 200. FIG. 2C shows an enlarged section of FIG. 2B as indicated by the dashed box labelled A.

The spark containment cap plate 20 is fixed to the structure 28 by a layer of adhesive 29. The cap 21c shows how the cap 21c would be once the spark containment cap plate 20 is fixed to the structure 28 and before any further steps are taken. The cap base 25 of each cap 21 is made of sacrificial material, such that a hole 201 can be drilled through the structure 28 and also through the sacrificial portion of the base 25, through which hole a fastener can be inserted. A common hole 201 has been drilled through the structure 28, the base 22 of the plate 20 and through the cap base 25 of cap 21b. A similar hole 201 has also been formed through into cap 21a, and furthermore, a blind fastener 202 has been inserted through the hole 201 and fastened into place.

As such, the cap 21a shows part of a completed fastener joint that is the end result once the blind fastener 202 has been fastened to the structure 28 as described above. In the completed fastener joint, the spark containment cap plate 20 is fixed to the structure 28 by a cured sealing material in the form of adhesive 29 provided between the base 22 and the surface of the structure 28. A protruding end 203 of the blind fastener 202 protrudes through the hole 201 formed in the structure 28 and spark containment cap plate 20, such that the end of the fastener 203 is enclosed within the cavity 26 in the enclosed body 23 defined by the cap base 25 and the cover portion 24.

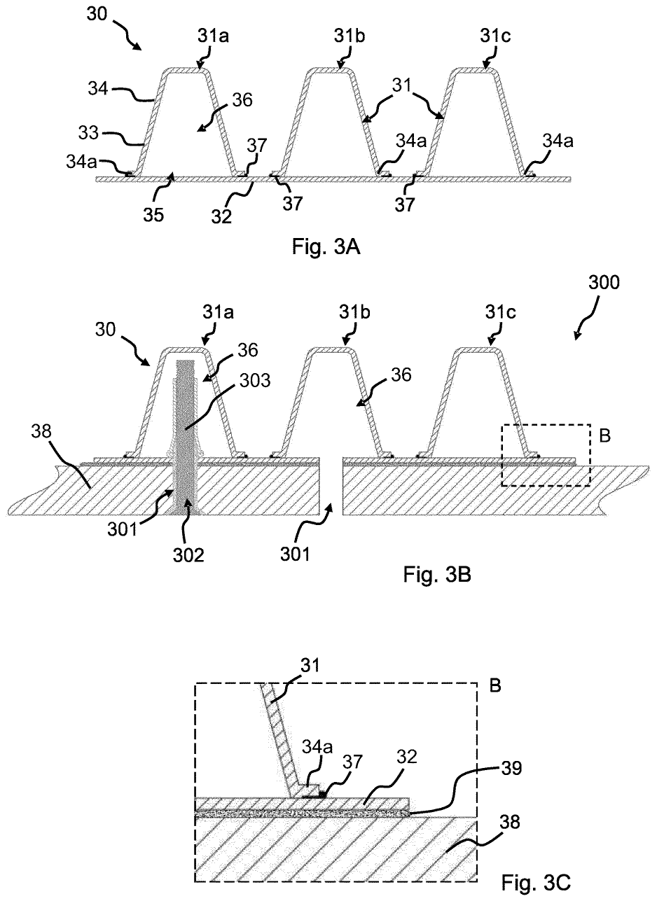

FIG. 3A shows a cross-sectional view through an alternative embodiment of a spark containment cap plate 30. Similarly to the first embodiment described above, the spark containment cap plate 30 comprises a base 32 and a number of spark containment caps 31 fixed to the base 32. In the embodiment shown, there are three spark containment caps 31a, 31b, and 31c. For clarity, reference numerals for features of each spark containment cap 31 will mostly only be shown in relation to spark containment cap 31a, however it will be understood that each of the spark containment caps 31a, 31b and 31c are identical, and so the reference numbers would also apply to 31b and 31c as well.

Each spark containment cap 31, which again may be referred to herein more simply as cap 31, comprises an enclosed body 33. Unlike the cap 21 of the first embodiment described above, this cap 31 doesn't have a cap base but instead simply has a cover portion 34. Instead of a cape base to enclose the cap 31, instead the cap 31 has an opening 35 defined by the annular end of the cover portion 34. However the cap 31 is still considered enclosed because the cap 31 is attached to the base 32 such that the base 32 closes the opening 35. The base 32 and cover portion 34 together define a cavity 36 within the enclosed body 33. It is into this cavity 36 that the end of a fastener can be received, which will be described in more detail below. The cover portion 34 comprises an outer flange 34a at the annular opening which provides an adhering surface that is used for adhering the cap 31 to the base 32. Adhesive 37 is provided in an annular ring between the caps 31a, 31b, 31c and the base 32. The adhesive 37 can be an epoxy adhesive, shim material or polysulphide sealant. For example, the epoxy adhesive may be a two-part epoxy adhesive such as 3M™ Scotch-Weld™ Structural Epoxy Adhesive 9323 or 3M™ Scotch-Weld™ Structural Epoxy Adhesive EC-7256 B/A. During assembly of the spark containment cap plate 30, adhesive 37 is applied to either the outer flange 34a or the base 32 and the spark containment caps 31 are positioned on the base 32 and the adhesive 37 is allowed to cure. Excess adhesive may form a small bead around the periphery of the cap 31 as shown in FIG. 3A (and more clearly shown in FIG. 3C). This bead helps to strengthen the bond between the cap 31 and the base 32, and will also act to seal the cavity 36 in order to prevent the ingress of fuel, water or other contaminants into the cavity 36, and also prevents plasma or other out-gassing products from exiting the cavity in the event of a lightning strike.

Similarly to the first embodiment, the base 32 in this second embodiment is formed of polymer or Glass Reinforced Plastic and is sized to fit a specific structural element of the wing/fuel tank. By giving the spark containment cap plate 30 a large base 32, this allows the caps 31 to be easily placed in precisely the right position onto a structure and also allows multiple caps 31 to be placed on one base 32 (three shown in FIGS. 3A and 3B), to allow for the installation of multiple caps 31 in one operation, thus saving significant time and cost. Although not shown in this embodiment, this also allows for different sized caps 31 to be installed together dependent on the specific fastener that the caps will be protecting.

In this embodiment, the caps 21 may be manufactured by injection molding. The caps 31 may be formed of a material such as ULTEM™ 2300. The caps 31 may require additional treatment or primer paint application to enhance adhesive properties depending on the requirements of the caps 31 and the spark containment cap plate 30.

FIG. 3B shows a cross-sectional view of the spark containment cap plate 30 affixed to a structure 38, and where each of the caps 31a, 31b and 31c are at different steps of a method of forming a fastener joint 300. FIG. 3C shows an enlarged section of FIG. 3B as indicated by the dashed box labelled B.

The spark containment cap plate 30 is fixed to the structure 38 by a layer of adhesive 39. The cap 31c shows how the cap 31c would be once the spark containment cap plate 30 is fixed to the structure 38 and before any further steps are taken. In this embodiment, none of the caps 31 comprise a cap base (as was the case for the first embodiment describe above in relation to FIGS. 2A, 2B and 2C) and as such a hole 301 that is drilled through the structure 38 is not also required to be drilled through a cap base. Instead, a common hole 301 has been drilled through the structure 38 and the base 32 of the plate 30 into the cavity 36 of cap 31b. A similar hole 301 has also been formed through into cap 31a, and furthermore, a blind fastener 302 has been inserted through the hole 301 and fastened into place.

The cap 31a shows part of a completed fastener joint 300 that is the end result once the blind fastener 302 has been fastened to the structure 38 as described above. In the completed fastener joint, the spark containment cap plate 30 is fixed to the structure 38 by a cured sealing material in the form of adhesive 39 provided between the base 32 and the surface of the structure 38. A protruding end 303 of the blind fastener 302 protrudes through the hole 301 formed in the structure 38 and spark containment cap plate 30, such that the end 303 of the fastener 302 is enclosed within the cavity 36 in the enclosed body 33 defined by the base 32 and the cover portion 34.

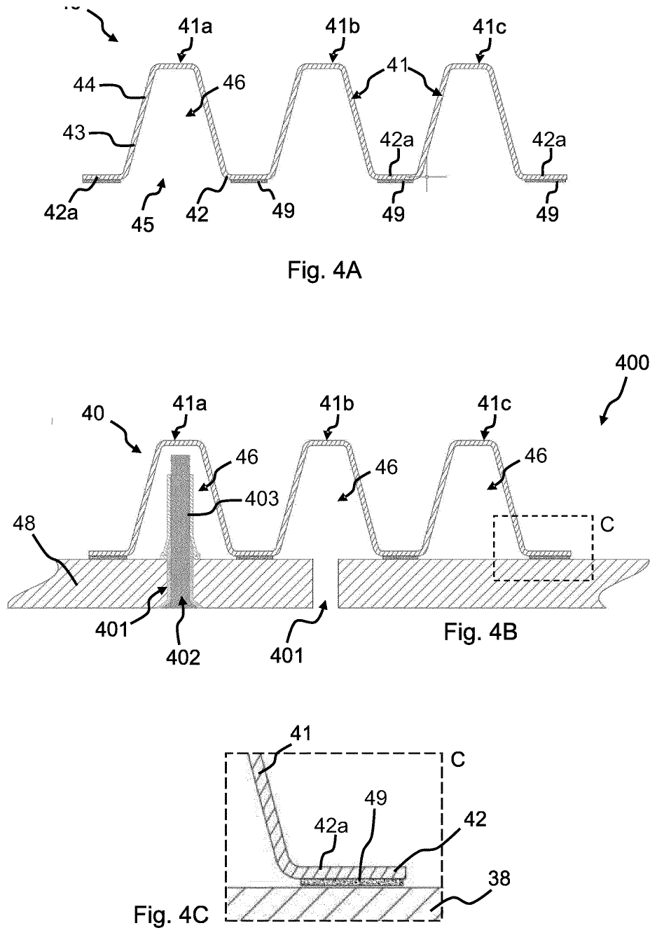

FIG. 4A shows a cross-sectional view through a further alternative embodiment of a spark containment cap plate 40. The spark containment cap plate 40 comprises a base 42 and a number of spark containment caps 41. In this embodiment, the spark containment caps 41 are molded into the base 42, such that the base 42 and the caps 41 are formed from a single piece of material. In the embodiment shown, there are three spark containment caps 41a, 41b, and 41c. For clarity, reference numerals for features of each spark containment cap 41 will mostly only be shown in relation to spark containment cap 41a, however it will be understood that each of the spark containment caps 41a, 41b and 41c are identical, and so the reference numbers would also apply to 41b and 41c as well.

Each spark containment cap 41 comprises a body 43. Unlike the caps 21 and 31 of the first and second embodiments described above, this cap 41 is not enclosed. Instead of a cape base or the base of the spark containment cap plate to enclose the cap, the cap 41 has a cover portion 44 and an opening 45. During use, as shown in FIG. 4B, the cap 41 will become enclosed when the spark containment cap 40 is attached to a surface of a structure 48. The surface of the structure 48 and cover portion 44 together define a cavity 46 within the now enclosed body 43. It is into this cavity 46 that the end of a fastener can be received. As the caps 41 are molded from the same material as the base 42, there is no need to adhere the cap 41 to the base 42.

The base 42 can be formed of a suitable moldable material, such as polymer or Glass Reinforced Plastic, and is sized to fit a specific structural element of the wing/fuel tank. By giving the spark containment cap plate 40 a large base 42, this allows the caps 41 to be easily placed in precisely the right position onto a structure and also allows multiple caps 41 to be molded into one base 42 (three shown in FIGS. 4A and 4B), to allow for the installation of multiple caps 41 in one operation, thus saving significant time and cost. Although not shown in this embodiment, it would also be possible for different sized caps 41 to be installed together dependent on the specific fastener that the caps will be protecting.

FIG. 4B shows a cross-sectional view of the spark containment cap plate 40 affixed to a structure 48, and where each of the caps 41a, 41b and 41c are at different steps of a method of forming a fastener joint 400. FIG. 4C shows an enlarged section of FIG. 4B as indicated by the dashed box labelled C.

On the spark containment cap plate 40 in between the caps 41, the base 42 has flat base portions 42a which provide an adhering surface that is used for adhering the spark containment cap plate 40 to the structure 48. Adhesive may be in the form of a two-part epoxy adhesive such as 3M™ Scotch-Weld™ Structural Epoxy Adhesive 9323 or 3M™ Scotch-Weld™ Structural Epoxy Adhesive EC-7256 B/A.

As described earlier, the caps 41 are now enclosed because the spark containment cap 40 is attached to the surface of the structure 48. The surface of the structure 48 and cover portion 44 together define a cavity 46 within the now enclosed body 43. Holes 401 have been drilled through the structure 48 into the cavities 46 of caps 41a and 41b. A blind fastener 402 has been inserted through the hole 401 of cap 41a and fastened into place.

The cap 41a therefore shows part of a completed fastener joint 400 that is the end result once the blind fastener 402 has been fastened to the structure 48 as described above. In the completed fastener joint, the spark containment cap plate 40 is fixed to the structure 48 by a cured sealing material in the form of adhesive 49 provided between the base 42 and the surface of the structure 48. A protruding end 403 of the blind fastener 402 protrudes through the hole 401 formed in the structure 48, such that the end 403 of the fastener 402 is enclosed within the cavity 46 in the enclosed body 43 defined by surface of the structure 48 and the cover portion 44.

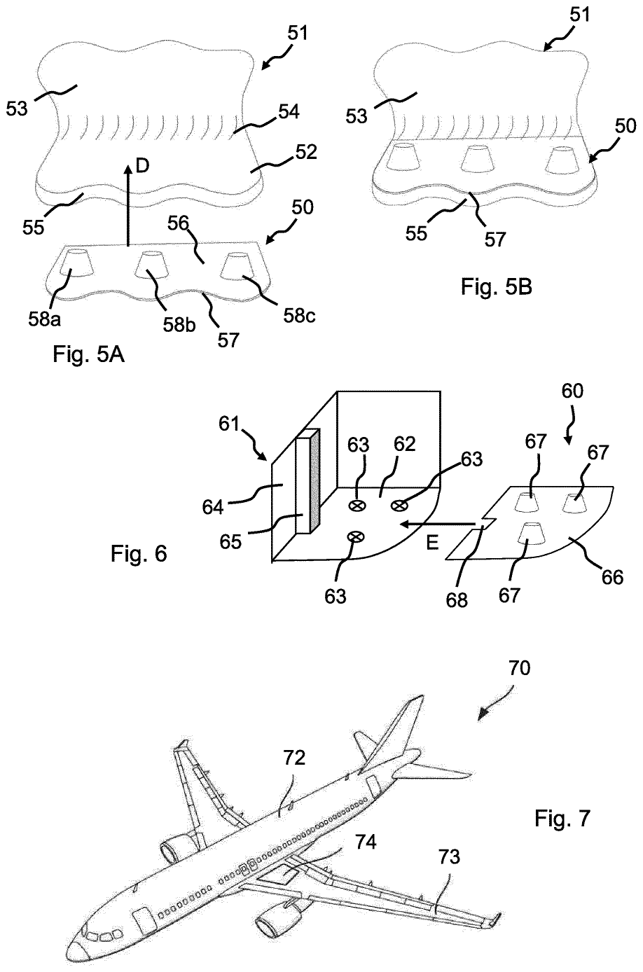

FIGS. 5A and 5B show the installation of a spark containment cap plate 50 onto a structure 51 having a complex shape. The structure 51 is given by way of an example of a structure with a complex shape, and comprises a first face 52 and a second face 53 which is substantially orthogonal to the first face 52. The first face 52 and second face 53 are connected by a curved section 54. The structure 51 has an outer edge 55 which follows a curved and non-uniform pathway, as may be required by some structures, particularly in aerospace applications, due to space constraints for example.

The structure 51, when in use on an aircraft, will have holes drilled through it and fasteners attached, and as such will be required to have lightning strike protection for the exposed ends of the fasteners. However, in this state, there are no holes yet drilled through the structure, and so it isn't easily obvious where the holes will be located. If individual spark containment caps were to be mounted to the structure, then careful positioning would be required for each cap, likely requiring measurement from a particular predetermined point on the non-uniform outer edge 55. This can be complex and time-consuming.

However, as shown in FIG. 5A, the spark containment cap plate 50 comprises a base 56 and three spark containment caps 58a, 58b and 58C. As such the plate 50 is provided with the caps 58a, 58b, 58c already positioned in exactly the right place. The base 56 also has an outer edge 57 which is shaped to align with the outer edge 55 of the structure 51. This makes installing the spark containment cap plate 50 very quick and easy as the outer edge 57 acts as an alignment feature with the outer edge 55 of the structure 51. To fix the plate 50 in place, an adhesive (not shown) is applied to either the surface of the first face 52, or the underneath of the base 56, and then the plate 50 is brought into position as indicated by arrow D, using the alignment of the outer edges 55 and 57 as a positioning guide. The adhesive is then allowed to cure.

FIG. 5B shows the resulting structure 51 with the plate 50 affixed in the correct position. A second plate (not shown) may be fixed to the second face 53 before the structure is then assembled into place, and the holes for the fasteners are drilled. The ability to fix the spark containment cap plate(s) in place on the structure, applying multiple spark containment caps with each plate, prior to the structure being used and any holes drilled can greatly reduce the complexity and time taken for assembly or an aircraft.

FIG. 6 shows the installation of a further embodiment of a spark containment cap plate 60 onto a structure 61 having a complex shape. The structure 61 is a corner joint, and has a surface 62 to which fasteners are to be fastened, as indicated by the fastener location marks 63. Side wall 64 has a rib feature 65 which extends along the side wall 64 and into abutment with surface 62.

The spark containment cap plate 60 comprises a base 66 and three spark containment caps 67. In this embodiment, the base 66 comprises a notch 68 which will engage with the rib feature 65 to help align and position the spark containment cap plate 60 onto the surface 62 of the structure 61.

The spark containment cap plates, fastener joints and corresponding methods of assembly described herein may be used in any application, but most preferably they are used in an aircraft such as the aircraft 70 shown in FIG. 7. The aircraft 70 includes a fuselage 72. Two wings 73 extend from the fuselage 72. It will be appreciated that the fuselage 72 and wings 73 may take a variety of different planned formed shapes and profiles depending on the particular application. Fuel tanks 74 are formed in the fuselage 72 and wings 73. One such fuel tank 74 is schematically shown in FIG. 7. The upper and lower boundaries of the tank 74 are provided by upper and lower skins of the wing 73, and the fore and aft boundaries are provided by forward and rear spars of the wing. In the embodiments described above, the spark containment cap plates and ends of blind fasteners may be located within the interior of the fuel tank 74.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

For example, in each of the embodiments described herein, the spark containment cap plate has been provided with the spark containment caps. However, alternative embodiments may comprise two caps, and others may contain more than three caps per plate. The number of caps provided on a plate will be dependent on the particular requirements of the application.

Furthermore, in the embodiments described above, the caps provided on the spark containment cap plates are all identical. However, the caps may differ. For example a structure may have two or more different sized fasteners to be used on it, and as such two or more different sized or shaped spark containment caps can be provided on the plate.

In addition, the adhesives described above which can be used to fix a spark containment cap to a spark containment cap plate, or also to fix a spark containment cap plate to a structure, are all two-part epoxy adhesives. However, in an alternative embodiment, an adhesive could be used which is cured using UV light. In this embodiment, it may be beneficial to form the spark containment cap and/or the spark containment cap plate from a transparent material which can allow UV curing of the adhesive through the cap.

The above embodiments are to be understood as illustrative examples of the invention. Equivalents and modifications not described above may also be employed without departing from the scope of the invention, which is defined in the accompanying claims.

It is to be understood that any feature described in relation to any one embodiment may be used alone, or in combination with other features described, and may also be used in combination with one or more features of any other of the embodiments, or any combination of any other of the embodiments.

It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

It should be noted that throughout this specification, “or” should be interpreted as “and/or”.

Although the invention has been described above mainly in the context of a fixed-wing aircraft application, it may also be advantageously applied to various other applications, including but not limited to applications on vehicles such as helicopters, drones, trains, automobiles and spacecraft.

1.-18. (canceled)

19. A spark containment cap plate comprising:
a base; and
two or more spark containment caps, each spark containment cap comprising a cover portion which extends from the base, and each cover portion defining a cavity inside the spark containment cap inside which is configured to enclosed an end of a fastener.

20. The spark containment cap plate as claimed in claim 19, wherein the base comprises an adhering surface for adhering each spark containment cap plate to a structure.

21. The spark containment cap plate as claimed in claim 19, wherein the base comprises one or more alignment features.

22. The spark containment cap plate as claimed in claim 21, wherein the one or more alignment features are configured to engage with a corresponding feature on a structural element to which the spark containment cap plate is secured.

23. The spark containment cap plate as claimed in claim 19, wherein the base is substantially planar.

24. The spark containment cap plate as claimed in claim 19, wherein the base has a non-planar profiled shape.

25. The spark containment cap plate as claimed in claim 19, wherein the base comprises two or more apertures, and
wherein a spark containment cap is located over each aperture.

26. The spark containment cap plate as claimed in claim 19, wherein the base comprises sacrificial material into which openings are formed such that fastener ends are received into the cavity of the one or the two or more spark containment caps.

27. The spark containment cap plate as claimed in claim 19, wherein the two or more spark containment caps are adhered to the base to form the spark containment cap plate.

28. The spark containment cap plate as claimed in claim 27, wherein each spark containment cap comprises a cap base, and each cap base is adhered to the base.

29. The spark containment cap plate as claimed in claim 27, wherein the cover portion of each spark containment cap comprises an annular opening, and
wherein each spark containment cap is adhered to the base at the annular opening.

30. The spark containment cap plate as claimed in claim 19, wherein the base and the two or more spark containment caps are formed from a single piece, and
wherein the spark containment caps are molded from a material that forms the base.

31. The spark containment cap plate as claimed in claim 19, wherein the base is formed of an electrically insulating material.

32. A method of securing a fastener and a spark containment cap plate to a structure, the method comprising the steps of:
fixing the spark containment cap plate as claimed in claim 19 onto a surface of the structure;
forming a hole through at least one of the structure and the spark containment cap plate at a location where the hole aligns with a spark containment cap; and
inserting a fastener through the hole and tightening the fastener to secure the fastener to the structure.

33. The method of claim 32, wherein the step of fixing the spark containment cap plate onto the surface of the structure comprises applying adhesive between the base of the spark containment cap plate and the structure, and curing the adhesive.

34. The method of claim 32, wherein the step of forming a hole comprises drilling a common hole through the structure and the base of the spark containment cap plate.

35. An aircraft comprising:
at least one spark containment cap plate of claim 19.

36. A fastener joint comprising:
a structure;
two or more fasteners, each fastener having a fastener end protruding from a surface of the structure; and
a spark containment cap plate, the spark containment cap plate comprising:
a base, and
two or more spark containment caps, each of the spark containment caps comprising a cover portion extending from the base, each cover portion defining a cavity inside the spark containment cap inside which is configured to enclosed the fastener ends of the two or more fasteners; and,
a cured sealing material provided between the spark containment cap plate and the structure which secures the spark containment cap plate to the structure in such a position that the fastener ends of the two or more fasteners are enclosed within a spark containment cap.
